(19) United States
(12) Patent Application Publication
(10) Pub. No.: US 2026/0160910 A1
(43) Pub. Date: Jun. 11, 2026

(54) METHOD AND DEVICE FOR MONITORING GENERATION OF COAL MINE VIBRATION AND ITS RESPONSE TO VIBRATION WAVE

(71) Applicant: SHANDONG UNIVERSITY OF SCIENCE AND TECHNOLOGY, Qingdao (CN)

(72) Inventors: Guangchao ZHANG, Qingdao (CN); Maosheng YIN, Qingdao (CN); You LI, Qingdao (CN); Zhaoyun ZHANG, Qingdao (CN); Xiangjun MENG, Qingdao (CN); Junpeng MA, Qingdao (CN); Chao WANG, Qingdao (CN); Kai LYU, Qingdao (CN); Bing GUI, Qingdao (CN); Guanglei ZHOU, Qingdao (CN); Miao CHEN, Qingdao (CN); Hengjie LUAN, Qingdao (CN); Xipo ZHAO, Qingdao (CN); Dong WANG, Qingdao (CN); Fangfang WANG, Qingdao (CN)

(21) Appl. No.: 19/071,403

(22) Filed: Mar. 5, 2025

Related U.S. Application Data
(63) Continuation of application No. PCT/CN2022/124763, filed on Oct. 12, 2022.

(30) Foreign Application Priority Data
Sep. 30, 2022 (CN) 202211207693.2

(51) Int. Cl. G01V 1/30; E21C 39/00; G01V 1/04

(52) U.S. Cl. CPC G01V 1/306; E21C 39/00; G01V 1/04; G01V 1/303; E21C 2100/00

(57) ABSTRACT

The present disclosure provides a method and device for monitoring generation of coal mine vibration and its response to vibration wave, the device comprises a frame, a vibration triggering device, an surface building model, an surface monitoring system, and an underground monitoring system. The present disclosure can simulate the mechanical process and phenomenon of high-energy and strong vibrations triggered by the fracture of the high-level thick-hard rock layers.

### CROSS-REFERENCE TO RELATED APPLICATIONS

This application is a continuation of International Application No. PCT/CN2022/124763 with a filling date of Oct. 12, 2022, designating the United states, now pending, and further claims to the benefit of priority from Chinese Application No. 202211207693.2 with a filing date of Sep. 30, 2022. The content of the aforementioned applications, including any intervening amendments thereto, are incorporated herein by reference.

### TECHNICAL FIELD

The present disclosure relates to the field of coal mine safety, particularly to a method and device for monitoring generation of coal mine vibration and its response to vibration wave.

### BACKGROUND

During coal mining operations, the thick-hard rock layer covering the stope face in the area where the coal seam is located and far away from the coal seam, is called the high-level thick-hard rock layer. Due to the strong integrity of the thick-hard rock layer and its tendency to form large areas of suspension, when the high-level thick-hard rock layer breaks, it is extremely easy to cause dynamic disasters in the mine, such as mining tremors, rockburst, and coal and gas outbursts, which seriously threaten the personal safety of underground workers.

The strong vibration caused by the fracture of the high-level thick-hard rock layers cannot be simulated and reproduced in the laboratory due to limitations such as model size, rock laying strength, and excavation range. Specifically, the model size and height are limited. High-energy and strong mine vibrations usually occur during the mining process of deep coal seams (over 600 m), mainly triggered by the fracture of high-level thick-hard rock layers far away from the coal seam (400-600 m). The height and size of common simulation experimental devices are limited. According to conventional similarity ratios, they can generally only lay formations of 200-400 m, making it impossible to lay high-level thick-hard rock layers, and thus unable to simulate the phenomenon of high-energy and strong vibrations caused by the fracture of high-level thick-hard rock layers and their impact on underground and surface.

At the same time, the research content of existing technology is to simulate the physical response caused by strong vibrations by applying dynamic loads outside the overall model. The focus of the research is on the effect of the vibration load generated, rather than studying the mechanical essence of vibration triggering, and does not pay attention to the mechanical process of rock fracture triggering large-scale strong vibrations. Specifically:

a. Rock Fractures Cannot Generate Energy

Due to various factors such as model size, rock layer laying strength, excavation range, etc., the elastic performance cannot be released when the rock layer breaks. In other words, conventional indoor simulation experiments can simulate the fracture of the rock layers, but cannot simulate the process of high-energy and strong vibrations caused by the fracture of the rock layers.

b. Unable to Simulate the Real Vibration Impact on the Surface and Underground

The value of vibration load has no theoretical basis and is seriously disconnected from engineering practice;

Applying vibration loads as a whole outside the model ignores the true propagation path of vibration loads: from vibration source to surrounding rock medium, and then to target object. Therefore, it is impossible to obtain the true impact of the vibrations on surface and underground structures, which deviates greatly from the actual engineering situation.

### SUMMARY

To solve the existing technical problems mentioned above, the present disclosure provides a method and device for monitoring generation of coal mine vibration and its response to vibration wave. The technical solution is:

A method for monitoring generation of coal mine vibration and its response to vibration wave, comprising:
S1, determining a number and spatial location of high-level thick-hard rock layers in an entire formation of a mining area,
S1-1 investigating a thickness, lithology, and stratigraphic sequence of rock layers in the entire formation,
S1-2 measuring and calculating engineering geological parameters of the rock layers in the entire formation of the mining area, including a vertical distance Hₙ between the rock layers with a single layer thickness of over 60 m and the coal seam, a ultimate tensile strength σₜₙ of the rock layers, a hardness coefficient fₙ of the rock layers, an elastic modulus Eₙ of the rock layers, a Poisson's ratio vₙ, and a maximum deflection wₙ of the rock layers; an average bulk density of the rock layers γ, and an original rock stress at the rock layers with a single layer thickness over 60 m σ₁ₙ, σ₂ₙ, σ₃ₙ, a comprehensive fracture angle α of the rock layers in a stope face, a burial depth of the coal seam, and a stope face slant length Sₗ,
S1-3 determining a number and an arrangement of the high-level thick-hard rock layers based on the engineering geological parameters of the rock layers calculated by S1-2, wherein, the rock layers located more than 150 m away from the coal seam and with a comprehensive score fₙ greater than 80 are identified as the high-level thick-hard rock layers capable of generating high-energy and strong vibrations;
S2, based on the engineering geological parameters obtained in step S1, calculating a fracture length Lan when each of the high-level thick-hard rock layers break and a corresponding stope face mining distance Len when each of the high-level thick-hard rock layers breaks, and determining a similarity ratio k of an experimental model based on a coal seam burial depth in the area where the coal seam is located and actual spatial conditions in a laboratory, and based on the similarity ratio k, calculating a distance x₀ₙ from a vibration source position of the experimental model to an excavation starting position, as well as a corresponding excavation distance L_{wn};
S3, calculating a true energy E_{Dn} for the fracture of the high-level thick-hard rock layers; and using a vibration triggering device to generate vibration source energy, the vibration source energy used in the vibration triggering device is a CO₂ detonation device, and calculating an equivalent relationship between the true energy E_{Dn} generated by the fracture of the high-level thick-hard rock layers in the area where the coal seam is located and an equivalent energy E_{gn} released by the CO₂ detonation device of the vibration triggering device;
S4, laying high-level thick-hard simulation rock blocks within a height adjustable frame, from bottom to top of the formation, and during laying of the high-level thick-hard simulation rock blocks, according to the distance x₀ₙ from the vibration source position of the experimental model calculated in step S2 to the excavation starting position, burying the vibration triggering device at the corresponding position in the formation; after laying the experimental model, the frame is at least 20 cm higher than the formation; installing an underground monitoring system at the bottom or front of the experimental model to monitor strong vibration impact on underground buildings; installing an surface building model at the top of the experimental model, and installing an surface monitoring system at a height of 10 cm above the surface building model;
S5, simulating triggering of the strong vibrations:
a. simulating coal seam mining in the stope face, and slowing down an excavation speed when the excavation reaches the distance L_{wn} or nL_{wn} where the high-level thick-hard rock layer is fractured, the vibration triggering device operates and triggers a high-energy and strong vibration phenomenon;
b. continuing excavation until the coal seam excavation is completed, after vibration triggering simulation, continuing excavation to trigger the next high-energy and strong vibration by the fracture of the high-level thick-hard rock layer, thus conducting multiple high-energy and strong vibration simulations;
c. the underground monitoring system and surface monitoring system obtain micro deformation and fracture information of a surrounding rock underground, a residual energy intensity information of the mining location, and a vibration velocity information in three mutually perpendicular directions on the surface, which are used to analyze the strong vibration impact in the actual mining area.

In one embodiment, wherein the comprehensive score of the high-level thick-hard rock layer is obtained by three parameters: the ultimate tensile strength σₜₙ, the hardness coefficient fₙ, a rock layer thickness hₙ, and their respective weights, comprising:
combining weight factors of the ultimate tensile strength σₜₙ, the hardness coefficient fₙ, and the rock layer thickness hₙ into a matrix A,

$$A = [ \begin{matrix}α \\ β \\ γ\end{matrix} ]$$

combining the ultimate tensile strength σₜₙ, the hardness coefficient fₙ, and the rock layer thickness hₙ into a matrix B,

$$B = [ \begin{matrix}{σ}_{tn} \\ {f}_{n} \\ {h}_{n}\end{matrix} ]$$

a final score Fₙ for the three parameters is:

$${F}_{n} = A \times {B}^{T} = [ \begin{matrix}α \\ β \\ γ\end{matrix} ] \times [ \begin{matrix}{σ}_{t n} & {f}_{n} & {h}_{n}\end{matrix} ]$$

the weights of σₜₙ, fₙ, and hₙ in matrix A are α=0.5, β=0.2, and γ=0.3;
the scoring values of σₜₙ, fₙ, and hₙ in matrix B are obtained from Table 1;

TABLE 1
parameters of the high-level thick-hard rock layers

| Parameters | | | Values and score changing range | | | | |
|---|---|---|---|---|---|---|---|
| 1 | ultimate | σₜₙ | <4 | 4~6 | 6~8 | 8~12 | >12 |
| | tensile | Score | 50 | 80 | 85 | 90 | 100 |
| | strength/MPa | | | | | | |
| 2 | hardness | fₙ | 2~4 | 4~6 | 6~8 | 8~10 | >10 |
| | coefficient | Score | 50 | 80 | 90 | 95 | 100 |
| 3 | rock layer | hₙ | <50 | 50~80 | 80~120 | 120~160 | >160 |
| | thickness/m | Score | 30 | 75 | 80 | 95 | 100 |

if the comprehensive score Fₙ is greater than 80, the rock layer is judged as the high-level thick-hard rock layer that can generate the high-energy and strong vibrations; according to the results, the thicknesses of the thick-hard rock layers in the formation are recorded from near to far from the coal seam as h₁, h₁ . . . hₙ.

In one embodiment, wherein a calculation formula for the true energy E_{Dn} of the fracture of the high-level thick-hard rock layer is:

$${E}_{D n} = {k}_{d n} \cdot ( {E}_{t n} + {E}_{s n} )$$

wherein, E_{Dn} is the true energy of the fracture of the high-level thick-hard rock layers, in units of J; k_{dn} is a stress transfer coefficient caused by rock excavation, which is 1.0-1.1; Ein is an elastic energy accumulated under triaxial stress within the rock mass, in units of J; Eₛₙ is a potential energy generated during the fracture of the high-level thick-hard rock layers, in units of J;
the elastic energy Eₜₙ accumulated under triaxial stress in the rock mass is calculated by:

$${E}_{tn} = ξ \cdot \frac{[ {σ}_{1 n}^{2} + {σ}_{2 n}^{2} + {σ}_{3 n}^{2} - 2 {υ}_{n} ( {σ}_{1 n} {σ}_{2 n} + {σ}_{1 n} {σ}_{3 n} + {σ}_{2 n} {σ}_{3 n} ) ]}{2 {E}_{n}}$$

wherein, ξ is an elastic energy accumulation parameter, taken as 100; σ₁ₙ, σ₂ₙ, and σ₃ₙ are three principal stresses in the rock mass, in units of MPa; vₙ is the Poisson's ratio of the rock mass; Eₙ is the elastic modulus, in units of GPa;
the potential energy Eₛₙ generated by the fracture of the high-level thick-hard rock layers is calculated by:

$${E}_{s n} = q \cdot {h}_{n} \cdot {L}_{d n} \cdot {S}_{l} \cdot γ \cdot Δ {h}_{n}$$

$$Δ {h}_{n} = {w}_{n}$$

wherein, q is an effective potential energy coefficient, taken as 0.5×10⁻³; hₙ, L_{dn}, and Stare the thickness, the fracture length, and the stope face slant length of the high-level thick-hard rock layers, respectively, in meters; γ is an average bulk density of the formation, measured in kN/m³; Δhₙ is an equivalent subsidence, in meters; wₙ is a maximum disturbance value of the corresponding rock layer.

In one embodiment, wherein the equal relationship between the true energy E_{Dn} of the fracture of the high-level thick-hard rock layer and the equivalent energy E_{gn} released by the CO₂ detonation device of the vibration triggering device is:

$${E}_{Dn} = \frac{1}{k} \cdot {E}_{gn} \cdot η$$

wherein, E_{Dn} is the true energy of the fracture of the high-level thick-hard rock layers, in units of J; k is the similarity ratio of the experimental model; E_{gn} is the equivalent energy released by the CO₂ detonation device, in units of J; n is an overall energy utilization rate of the vibration triggering device, taken as 0.85;
a peak pressure of CO₂ gas inside the vibration triggering device is calculated by:

$${P}_{gn} = ζ \cdot \frac{2 {σ}_{s} {δ}_{n}}{{R}_{n}}$$

wherein, P_{gn} is a peak gas burst pressure, measured in Pa; ζ is a conversion coefficient between a fracturing tube used in the vibration triggering device and a standard CO₂ fracturing tube, usually taken as 0.76-0.95; Rₙ is a radius of a discharge hole, measured in millimeters; σₛ is a shear strength of a shear plate material, taken as 370 MPa; δₙ is thickness of the shear plate, measured in millimeters;
the formula for calculating a volume usage of CO₂ is:

$${V}_{n} = {k}_{v} \cdot \frac{{E}_{gn} \cdot ( K - 1 )}{{P}_{gn}} [ 1 - {( \frac{{P}_{0}}{{P}_{gn}} )}^{\frac{K - 1}{K}} ]$$

wherein, Vₙ is a volume of CO₂ used, measured in cubic meters; kᵥ is an energy density coefficient, taken as 0.1; E_{gn} is the equivalent energy released by the CO₂ detonation device, in units of J; P_{gn} is the gas burst pressure, in units of Pa; P₀ is a standard atmospheric pressure, taken as 0.1013 MPa; K is an adiabatic coefficient of CO₂, taken as 1.295.

A device for monitoring generation of coal mine vibration and its response to vibration wave, comprising:
a height adjustable frame used to simulate a distribution structure of high-level thick-hard rock layers in a stope face;
a vibration triggering device, installed at a suitable position on the frame; the vibration triggering device comprises a fracturing tube, a vibration triggering device, a pressure relief valve, and a triggering mechanism, the vibration triggering device is fixedly installed inside the fracturing tube, the pressure relief valve is set inside the fracturing tube, and the triggering mechanism is fixedly installed outside the fracturing tube;
the vibration triggering device comprises a housing, a blocking stopper, and a shear plate; two ends of the housing are open, and a top end of the housing is sealed by a safety film, a bottom end is equipped with a blocking stopper, which is a hollow structure; a circular flange is provided in the middle of the housing, and the shear plate is installed between the circular flange and the blocking stopper; the safety film, the shear plate, and the housing form a chamber for storing liquid CO₂;
the fracturing tube is equipped with a fracturing tube stopper inside, which is located directly below the vibration triggering device and opposite to the blocking stopper, the fracturing tube stopper and the blocking stopper form a pressure relief valve, which provides a high-pressure vibration wave discharging channel for the liquid CO₂ after gasification;
the triggering mechanism is used to sense stress changes and trigger the operation of the vibration triggering device, the operation of the vibration triggering device provides source energy, which impacts and destroys the fracturing tube through the pressure relief valve, thereby enabling the vibration triggering device to operate and provide vibration source energy to a surrounding environment;
an surface building model installed at the top of the frame; and a vibration wave response monitoring device comprising:
an surface monitoring system installed above the frame and at a height higher than an installation height of the surface building model, used to monitor impacts of high-energy and strong vibrations on buildings; and
an underground monitoring system installed at the bottom or front of the frame to monitor the relevant vibration impact on underground structures.

In one embodiment, wherein the underground monitoring system includes an acoustic emission device and a microseismic monitoring device, the acoustic emission device is used to detect microscopic deformation and fracture of surrounding rocks caused by strong mine vibrations underground; the microseismic monitoring device is used to monitor a residual energy intensity transmitted to a mining site after an interaction and energy attenuation of the surrounding rocks caused by the vibrations generated by the source location.

In one embodiment, wherein the surface monitoring system includes a blasting vibration instrument, including a three-way vibration sensor and a signal acquisition instrument, which can automatically record and analyze a vibration velocity in three mutually perpendicular directions.

In one embodiment, wherein the triggering mechanism is installed above the safety film, and the triggering mechanism comprises a resistive stress sensor, a transmission wire, and an electrical signal control valve, the electrical signal control valve is installed in contact with the safety film and is connected to the resistive stress sensor through the transmission wire.

In one embodiment, wherein the frame comprises two bases, on which longitudinal support components capable of being raised are installed, and the longitudinal support components are connected and fixed by bottom beams, the longitudinal support components are installed with front and rear beams arranged in parallel from bottom to top, and are respectively installed on the front and rear sides of the longitudinal support components, a space for laying the high-level thick-hard simulation rock blocks is formed between the front and rear beams and the longitudinal support components, the height of the longitudinal support components and the number of front and rear beams can be changed according to the thickness of the high-level thick-hard simulation rock blocks laid, a vibration triggering device is installed inside the high-level thick-hard rock simulation block.

In one embodiment, wherein the longitudinal support component comprises multiple structural units connected and installed by bolt stacking, and the height of the longitudinal support component relative to the base is changed by increasing the number of stacking of the structural units, to meet the height requirements of the experiment.

In one embodiment, wherein at least three vibration triggering devices are installed at positions x₀ₙ−δ, x₀ₙ, x₀ₙ+δ, wherein δ is 5-10 cm.

The beneficial effects of the present disclosure are:

The device and method provided by the present disclosure can simulate the mechanical process of the fracture of the high-level thick-hard rock layers and trigger high-energy and strong vibrations, and can simulate the process and phenomenon of the fracture of the high-level thick-hard rock layers and triggering strong vibrations.

The device provided by the present disclosure solves the key problem of limited height and size of common experimental devices, which makes it impossible to lay high-level thick-hard rock layers, and thus cannot simulate the phenomenon of strong vibrations caused by the fracture of the thick-hard rock layers and its impact on the surface. It also solves the key problem of the inability to release elastic properties when the rock layers break due to various factors such as model size, rock layer laying strength, and excavation range, and thus cannot simulate the triggering of strong vibrations caused by the fracture of high-level thick-hard rock layers.

The device and method provided by the present disclosure solve the key problem of the inability to simulate the real impact of the vibrations on the surface and underground in the existing technology. By calculating the true energy of the vibration source in on-site engineering, the source of strong vibration energy can be based on evidence, and the true impact of the vibrations on surface and underground structures can be obtained based on the true propagation path, i.e. from the vibration source to surrounding rock medium to target object, which is consistent with the actual engineering situation.

### BRIEF DESCRIPTION OF THE DRAWINGS

FIG. 1 is a schematic diagram of the frame structure according to the present disclosure;

FIG. 2 is a schematic diagram of the longitudinal support components and structural units;

FIG. 3 is a schematic diagram of the structure of the vibration triggering device;

FIG. 4 shows the schematic diagram of the burial location of the vibration triggering device, the surface monitoring system, the surface building model, and the underground monitoring system;

FIG. 5 is a schematic diagram of the burial distribution of multiple vibration triggering devices;

FIG. 6 is a schematic diagram of the distribution of the high-level thick-hard rock layers in engineering geological surveys;

FIG. 7 is a schematic diagram of the structure of the high-level thick-hard rock layer simulation block 4 laid within the frame;

FIG. 8 shows the attenuation rule of the vibration velocity of the surface building model as a function of distance.

1—base, 2—longitudinal support components, 3—structural unit, 3-1—threaded hole, 3-2—nut, 3-3—screw, 4—high-level thick-hard rock simulation block, 5—vibration triggering device, 6—bottom beam, 7—front beam, 8—rear beam, 9—fracturing tube, 10—pressure relief valve, 11—housing, 12—blocking stopper, 13—shear plate, 14—annular flange, 15—chamber, 16—safety film, 17—surface building model, 18—fracturing tube stopper, 19—resistive stress sensor, 20—transmission wire, 21—electrical signal control valve, 22—surface monitoring system, 23—underground monitoring system, 23-1—microseismic monitoring Device, 23-2—acoustic emission device.

### DETAILED DESCRIPTION

In order to make the technical problems, technical solutions and beneficial effects of the present invention clearer, the present invention will be further described in detail below with reference to the accompanying drawings and embodiments.

In the present invention, the terms “first,” “second,” and “third” are merely for the purpose of description, but cannot be understood as indicating or implying relative importance.

In the description of the present invention, it should be understood that if orientation or position relations indicated by the terms such as “upper,” “lower,” “left,” “right,” “front,” “back,” and the like are based on the orientation or position relations shown in the drawings, and the terms are intended only to facilitate the description of the present invention and simplify the description, rather than indicating or implying that the apparatus or element referred to must have a particular orientation and be constructed and operated in the particular orientation, and therefore cannot be construed as a limitation on the present invention.

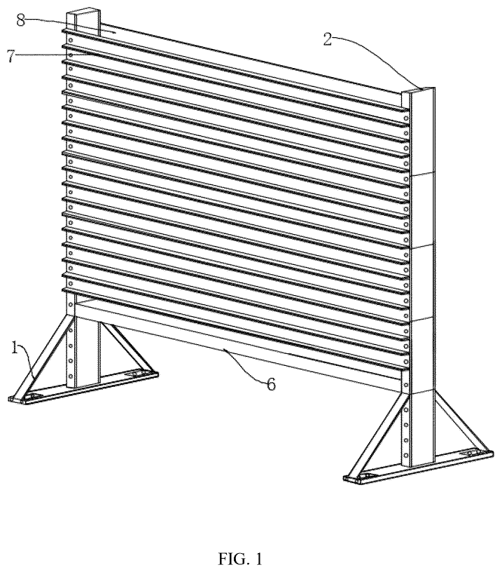

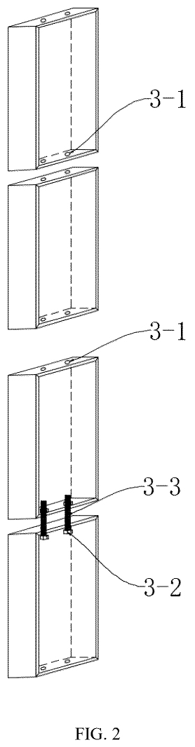

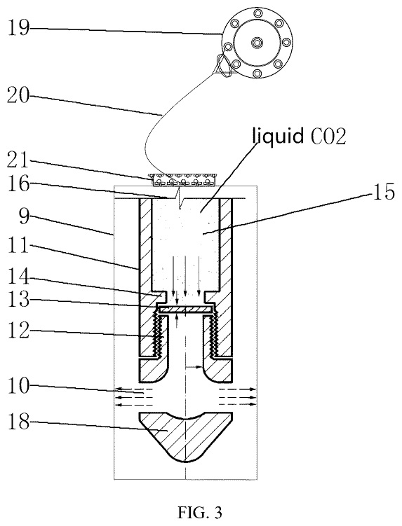

As shown in FIG. 1-3, a device for monitoring generation of coal mine vibration and its response to vibration wave includes a frame, a vibration triggering device, an surface building model 17, and a vibration wave response monitoring device.

The frame includes two bases 1, on which longitudinal support components 2 that can be raised are installed. The longitudinal support components 2 include multiple structural units 3, and the connecting surfaces of the structural units 3 are correspondingly opened with threaded holes 3-1. They are connected and stacked by screws 3-3 and nuts 3-2. By increasing the number of stacked structural units 3, the height of the longitudinal support components 2 relative to the base 1 can be changed, so that the device meets the height requirements of the experiment.

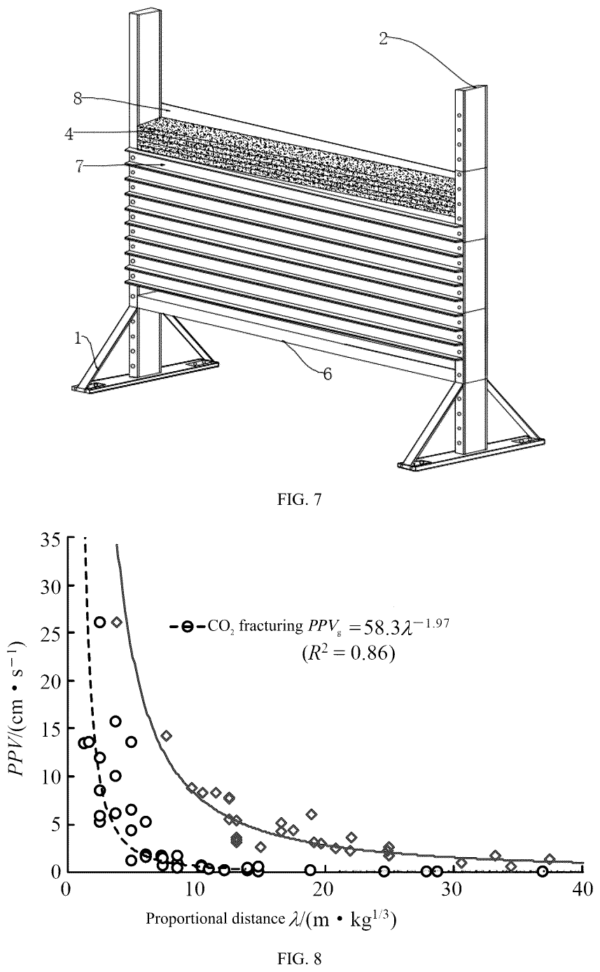

As shown in FIG. 7, the longitudinal support components 2 are connected and fixed by a bottom beam 6. The longitudinal support components 2 are installed with front and rear beams arranged in parallel from bottom to top. The front and rear beams 7 and 8 are respectively installed on the front and rear sides of the longitudinal support components 2. A space is formed between the front and rear beams 7 and 8 and the longitudinal support components 2 to lay the high-level thick-hard simulation rock blocks 4. The height of the longitudinal support components 2 and the number of front and rear beams 7 and 8 can be adjusted according to the thickness of the high-level thick-hard simulation rock blocks 4. A vibration triggering device 5 is installed inside the high-level thick-hard rock simulation block 4.

The vibration triggering device 5 includes a fracturing tube 9, a vibration triggering device, a pressure relief valve 10, and a triggering mechanism.

The vibration triggering device is fixedly installed inside the fracturing tube 9, the pressure relief valve 10 is set inside the fracturing tube 9, and the triggering mechanism is fixedly installed outside the fracturing tube 9.

The vibration triggering device comprises a housing 11, a blocking stopper 12, and a shear plate 13.

The two ends of the housing 11 are open, and a top end of the housing is sealed by a safety film 16. The middle of the housing 11 is provided with a circular flange 14, and the bottom is provided with an internal thread.

A bottom end of the housing 11 is equipped with a blocking stopper 12, which is a hollow structure with two open ends and is provided with external threads that match the internal threads of the housing 11. A shear plate 13 is installed between the annular flange 14 and the blocking stopper 12. The safety film 16, the shear plate 13, and the housing 11 form a chamber 15, which is used to store liquid CO₂.

The fracturing tube 9 is equipped with a fracturing tube stopper 18 inside, which is located directly below the vibration triggering device and opposite to the blocking stopper 12. The fracturing tube stopper 18 and the blocking stopper 12 form a pressure relief valve 10, which provides a high-pressure vibration wave discharging channel for the vaporized liquid CO₂.

To provide a buffering effect, a buffering groove is set on the upper end face of the fracturing tube stopper 18, and a circular arc angle is set on the lower end face of the blocking stopper. A circular guide angle is set at the opening of the blocking stopper 12 facing the fracturing tube stopper 18 to guide the vibration wave generated by the vaporized CO₂ and discharge it through the pressure relief valve 10.

The triggering mechanism is installed on the outside of the fracturing tube. The triggering mechanism includes a resistive stress sensor 19, a transmission wire 20, and an electrical signal control valve 21. The electrical signal control valve 21 is installed in contact with the safety film 16 and connected to the resistive stress sensor 19 through the transmission wire 20.

The operating principle of the vibration triggering device is:

The resistive stress sensor 19 senses changes in external stress and converts them into electrical signals, which are then transmitted to the electrical signal control valve 21 through the transmission wire 20.

The electrical signal control valve 21 uses microcurrents to generate high temperatures, which penetrate the safety film 16 and vaporize the liquid CO₂ inside the chamber 15.

The rapidly expanding CO₂ gas generates a high-pressure vibration wave, which breaks the shear plate 13 and is discharged from the pressure relief valve 10. Its high-pressure and high-energy vibration wave acts on the environmental medium, simulating the high-energy and strong vibration phenomenon caused by the dynamic impact of compressed air generated by the fracture of high-level thick-hard rock layers.

The surface building model 17 is installed at the top of the frame.

The vibration wave response monitoring device includes an surface monitoring system 22 and an underground monitoring system 23.

Installing an surface monitoring system 22 at a location higher than the surface building model 17 to monitor the impact of high-energy and strong vibrations on buildings. The surface monitoring system 22 includes a blasting vibration instrument, which specifically includes a three-way vibration sensor and a signal acquisition instrument, which can automatically record and analyze the vibration velocity in three mutually perpendicular directions.

Installing an underground monitoring system 23 at the bottom or front of the frame to monitor the vibration impact on underground structures. The underground monitoring includes an acoustic emission device 23-2 and a microseismic monitoring device 23-1. The acoustic emission device 23-2 mainly detects the microscopic deformation and fracture of the underground surrounding rock caused by strong vibrations. The microseismic monitoring device 23-1 can monitor the residual energy intensity transmitted to the mining site after the interaction and energy attenuation of the surrounding rock caused by the vibrations generated by the source location.

A method for monitoring generation of coal mine vibration and its response to vibration wave using the device described above, comprising:

S1, determining whether there are large fault zones near the stope face of the mine, measuring the thickness of the rock layers in the entire formation of the mining area, determining the stratigraphic sequence of the rock layers, selecting the rock layers with a single layer thickness hₙ≥60 m as the measured object, and calculating the engineering geological parameters of the mining area.

The engineering geological parameters include:
The vertical distance Hₙ between the rock layer and the coal seam is denoted as H₁, H₂ . . . Hₙ respectively, from the nearest to the farthest from the coal seam;
The ultimate tensile strength σₜₙ of the rock layers is denoted as σₜ₁, σₜ₂ . . . σₜₙ;
The hardness coefficient fₙ of the rock layers is denoted as f₁, f₂ . . . fₙ;
The elastic modulus Eₙ of the rock layers is denoted as E₁, E₂ . . . Eₙ;
A Poisson's ratio vₙ of the rock layers is denoted as v₁, v₂ . . . vₙ;
The maximum deflection wₙ of the rock layers is denoted as w₁, w₂ . . . wₙ,
The original rock stress at the rock layers is σ₁ₙ, σ₂ₙ, σ₃ₙ,
The average bulk density of the entire rock layer is γ;
The comprehensive fracture angle of rock layer in a stope face is α;
The coal seam burial depth and the stope face slant length Sₗ;

S2, according to the judgment criteria, determining the number of the high-level thick-hard rock layers in the entire formation of the mining area, and marking the thickness of the high-level thick-hard rock layers in the order of distance from the coal seam from near to far as h₁, h₂ . . . hₙ.

The judgment criteria are: the vertical distance Hₙ between the rock layer and the coal seam is ≥150 m, and the comprehensive score fₙ of the rock layers is greater than 80.

The comprehensive evaluation value fₙ of the rock layers is obtained by combining the evaluation scores and weights of three parameters: the ultimate tensile strength σₜₙ, the hardness coefficient fₙ, and the rock layer thickness hₙ.

The calculation formula (1) is:

$$A = [ \begin{matrix}α \\ β \\ γ\end{matrix} ] , B = [ \begin{matrix}{σ}_{m} \\ {f}_{n} \\ {h}_{n}\end{matrix} ] \qquad ( 1 )$$

$${F}_{n} = A \times {B}^{T} = [ \begin{matrix}α \\ β \\ γ\end{matrix} ] \times [ \begin{matrix}{σ}_{m} & {f}_{n} & {h}_{n}\end{matrix} ]$$

wherein, the weights of σₜₙ, fₙ, and hₙ in matrix A are α=0.5, β=0.2, and γ=0.3;
the scoring values of σₜₙ, fₙ, and hₙ in matrix B are obtained from Table 1;

TABLE 1
Table 1: parameters of the high-level thick-hard rock layers

| Parameters | | | Values and score changing range | | | | |
|---|---|---|---|---|---|---|---|
| 1 | ultimate | σₜₙ | <4 | 4~6 | 6~8 | 8~12 | >12 |
| | tensile | Score | 50 | 80 | 85 | 90 | 100 |
| | strength/MPa | | | | | | |
| 2 | hardness | fₙ | 2~4 | 4~6 | 6~8 | 8~10 | >10 |
| | coefficient | Score | 50 | 80 | 90 | 95 | 100 |
| 3 | rock layer | hₙ | <50 | 50~80 | 80~120 | 120~160 | >160 |
| | thickness/m | Score | 30 | 75 | 80 | 95 | 100 |

S3, calculating a span Lan (unit: m) when a high-level thick-hard rock layer breaks in actual engineering. The calculation formula (2) is:

$${L}_{dn} = λ \cdot \sqrt{\frac{2 {h}_{n} \cdot {σ}_{tn}}{γ}} \qquad ( 2 )$$

wherein, A is the complexity coefficient of the geological structures, with a range of 0.8-1.0. The more complex the geological structure, the smaller the value of 2;
Hₙ is the thickness of the high-level thick-hard rock layer, in meters;
σₜₙ is the ultimate tensile strength of the high-level thick-hard rock layers, in units of MPa;
γ is the average bulk density of the high-level thick-hard rock layers, measured in kN/m³;

S4, calculating the corresponding stope face mining distance L_{cn} when the high-level thick-hard rock layer breaks, formula (3) is:

$${L}_{cn} = {L}_{dn} + 2 {H}_{n} cot α \qquad ( 3 )$$

wherein, Len is the mining distance of the stope face when the high-level thick-hard rock layer breaks, in meters;
Hₙ is the vertical distance between the high-level thick-hard rock layer and the coal seam, in meters;
α is the comprehensive fracture angle of the high-level thick-hard rock layers, measured in degrees.

S5, based on the coal seam burial depth in the area where the coal seam is located and the actual spatial conditions in the laboratory, determining the similarity ratio k of the experimental model, which ranges from 1:50 to 1:500; based on the similarity ratio k, calculating the distance x₀ₙ from the vibration source position of the experimental model to the excavation starting position, as well as the corresponding excavation distance L_{wn}. The calculation formulas (4) and (5) are as follows:

$${x}_{0 n} = k \cdot {L}_{dn} \qquad ( 4 )$$

$${L}_{wn} = k \cdot {L}_{cn} \qquad ( 5 )$$

wherein, x₀ₙ is the distance from the vibration source position to the excavation starting position, in meters;
k is the similarity ratio of the experimental model;
L_{wn} is the excavation distance corresponding to the fracture of the high-level thick-hard rock layers in indoor simulation experiments, in meters;

S6, calculating a true energy E_{Dn} of the fracture of the high-level thick-hard rock layer, which includes the accumulated elastic energy Eₜₙ in the rock mass and the potential energy Eₛₙ generated by the subsidence during fracture. The calculation formula (6) is:

$${E}_{Dn} = {k}_{dn} \cdot ( {E}_{tn} + {E}_{sn} ) \qquad ( 6 )$$

wherein, E_{Dn} is the true energy of the fracture of the high-level thick-hard rock layers, in units of J;
k_{dn} is the stress transfer coefficient caused by excavation of the high-level thick-hard rock layers, generally is 1.0-1.1;
Eₜₙ is the elastic energy accumulated under triaxial stress within the rock mass, in units of J; Eₛₙ is the potential energy generated during the fracture of a high-level thick-hard rock layer, in units of J.

The calculation formula (7) for the elastic energy Eₜₙ accumulated under triaxial stress in the rock mass is:

$${E}_{tn} = ξ \cdot \frac{[ {σ}_{1 n}^{2} + {σ}_{2 n}^{2} + {σ}_{3 n}^{2} - 2 {υ}_{n} ( {σ}_{1 n} {σ}_{2 n} + {σ}_{1 n} {σ}_{3 n} + {σ}_{2 n} {σ}_{3 n} ) ]}{2 {E}_{n}} \qquad ( 7 )$$

wherein, ξ is the elastic energy accumulation parameter, usually taken as 100;
σ₁ₙ, σ₂ₙ, σ₃ₙ are the three principal stresses in the rock mass, in units of MPa;
vₙ is a Poisson's ratio of the high-level thick-hard rock layers;
Eₙ is the elastic modulus, in units of GPa.

The calculation formulas (8) and (9) for the potential energy Eₛₙ generated during the fracture of the high-level thick-hard rock layers are as follows:

$${E}_{sn} = q \cdot {h}_{n} \cdot {L}_{dn} \cdot {S}_{l} \cdot γ \cdot Δ {h}_{n} \qquad ( 8 )$$

$$Δ {h}_{n} = {w}_{n} \qquad ( 9 )$$

wherein, Q is the effective potential energy coefficient, usually taken as 0.5×10⁻³;
hₙ, L_{dn}, Sₗ are the thickness, fracture length, and stope face slant length of the high-level thick-hard rock layer, respectively, in meters;
γ is the average bulk density of the formation, measured in kN/m³;
Δhₙ is the equivalent subsidence, in meters;
wₙ is the maximum disturbance value of the corresponding rock layer.

S7, the device used in this method uses a mini-type CO₂ detonation device as the vibration source energy for the vibration triggering device. The equivalent relationship between the actual energy E_{Dn} of the high-level thick-hard rock layer in the area where the coal seam is located and the equivalent energy E_{gn} released by the CO₂ detonation device of the vibration triggering device is calculated as follows, and the calculation formula (10) is:

$${E}_{Dn} = \frac{1}{k} \cdot {E}_{gn} \cdot η \qquad ( 10 )$$

wherein, E_{Dn} is the true energy of the fracture of the high-level thick-hard rock layers, in units of J;
k is the similarity ratio of the experimental model;
E_{gn} is the equivalent energy released by the CO₂ detonation device, in units of J;
η is the overall energy utilization rate of the vibration triggering device, usually taken as 0.85.

In the vibration triggering device, the peak pressure of CO₂ gas inside the fracturing tube is calculated according to the following formula (11):

$${P}_{gn} = ζ \cdot \frac{2 {σ}_{s} {δ}_{n}}{{R}_{n}} \qquad ( 11 )$$

wherein, P_{gn} is the peak burst pressure of CO₂ gas, expressed in units of Pa;
ζ is the conversion coefficient between the fracturing tube used and the standard CO₂ fracturing tube, usually taken as 0.76-0.95;
Rₙ is the radius of the pressure relief valve, measured in millimeters; σₛ is the shear strength of the shear plate material, taken as 370 MPa;
δₙ is the thickness of the shear plate, measured in millimeters.

The formula (12) for calculating the volumetric amount of CO₂ is:

$${V}_{n} = {k}_{v} \cdot \frac{{E}_{gn} \cdot ( K - 1 )}{{P}_{gn}} [ 1 - {( \frac{{P}_{0}}{{P}_{gn}} )}^{\frac{K - 1}{K}} ] \qquad ( 12 )$$

wherein, Vₙ is the volume of CO₂ used, measured in cubic meters;
kᵥ is the energy density coefficient, usually taken as 0.1;
E_{gn} is the equivalent energy released by the CO₂ detonation device, in units of J;
P_{gn} is the gas burst pressure, in units of Pa;
P₀ is the standard atmospheric pressure, taken as 0.1013 MPa;
K is the adiabatic coefficient of CO₂, taken as 1.295.

S8, laying the experimental model, laying the high-level thick-hard rock simulation block 4 within a height adjustable frame, and making high-level thick-hard rock simulation block 4 using materials such as river sand and gypsum mixed together. After laying the experimental model, it is dried and cured for 1-2 weeks. When laying the experimental model:

Starting from bottom to top of the formation, the experimental model is laid layer by layer, and the height of the longitudinal support component 2 is gradually increased with the laying of the high-level thick-hard rock simulation block 4, while always keeping the front and rear beams 10-20 cm higher than the already laid formation.

During laying the high-level thick-hard simulation rock blocks, according to the distance x₀ₙ from the vibration source position of the experimental model calculated in step S5 to the excavation starting position, the vibration triggering device is buried at the corresponding position of the formation. When the experimental model is laid, it should be ensured that the front beam, rear beam, and longitudinal support components are at least 20 cm higher than the laying layer, in order to place the surface monitoring system and surface building model on top of the experimental model.

An underground monitoring system at the bottom or front of the experimental model is installed to monitor the vibration impact on underground buildings. The underground monitoring system comprises an acoustic emission device and a microseismic monitoring device, wherein the acoustic emission device is used to detect the microscopic deformation and fracture of the surrounding rock caused by strong vibrations. The microseismic monitoring device is used to monitor the residual energy intensity transmitted to the mining site after the interaction and energy attenuation of the surrounding rock caused by the vibrations generated by the source location.

An surface building model is installed at the top of the experimental model, and an surface monitoring system is installed at a height of 10 cm above the surface building model. The surface monitoring system comprises a blasting vibration instrument, which includes a three-way vibration sensor and a signal acquisition instrument. The surface monitoring system is used to automatically record and analyze the vibration velocity in three mutually perpendicular directions.

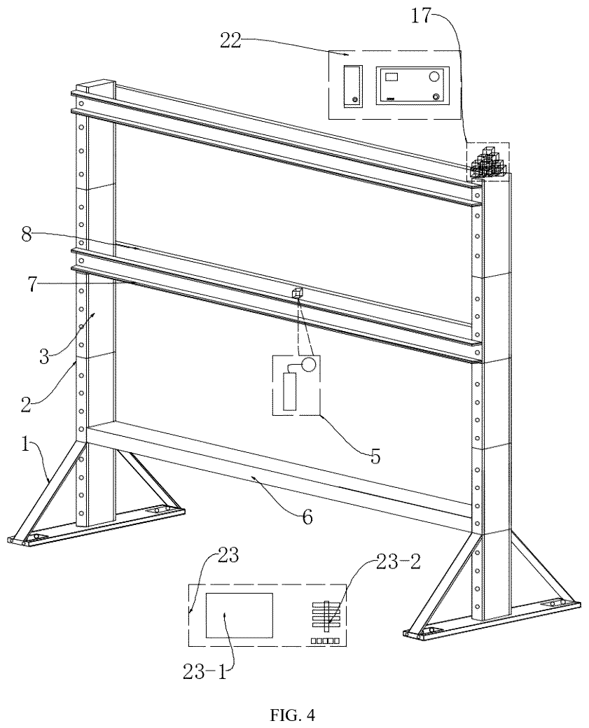

S9, according to the distance x₀ₙ from the vibration source position to the excavation starting position calculated in step S5, as shown in FIG. 4, the vibration triggering device is buried at the corresponding position of the experimental model.

Specifically, at the three positions of “x₀ₙ−δ”, “x₀ₙ”, and “x₀ₙ+δ”, δ can be taken as 5-10 cm, and a vibration triggering device should be buried respectively to ensure that the stress reduction effect generated when the high-level thick-hard rock layer breaks in the experimental model frame is monitored by a resistive stress sensor.

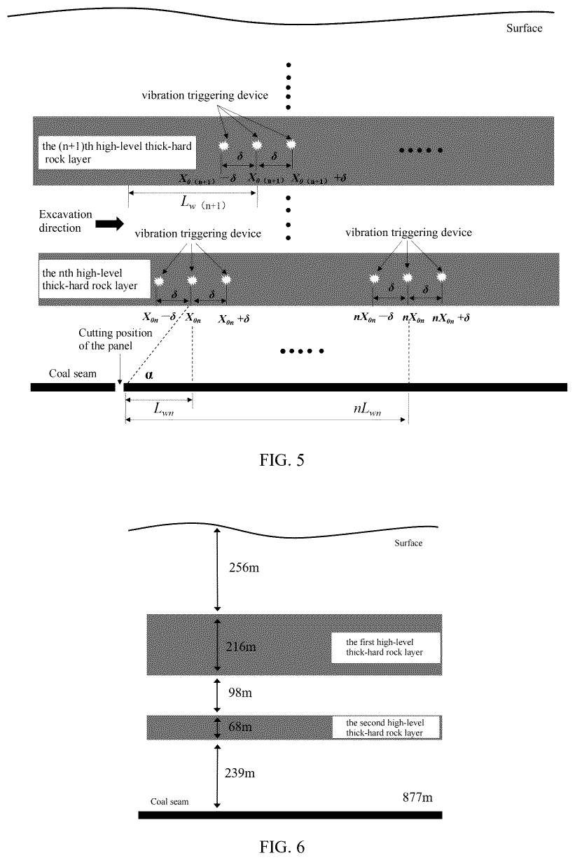

As shown in FIG. 5, as a preferred option, multiple vibration triggering devices can be buried at the nx₀ₙ±δ cm position, where n takes natural numbers 2, 3, etc., to simulate the phenomenon of the fracture of the high-level thick rock layers and triggering high-energy and strong vibrations in the engineering site where the coal seam is located.

S10, simulating and obtaining the triggering process of strong vibrations.

a. in the experimental model, normal excavation is carried out to simulate coal seam mining in the stope face. When the excavation reaches a distance L_{wn} or nL_{wn} (where n is a natural number of 1, 2, 3, etc.) close to the high-level thick-hard rock layer, the excavation speed is slowed down.

The high-level thick-hard rock layer gradually reaches its ultimate tensile strength and fractures as the stope face is excavated. The stress at the fracture location decreases accordingly. At this time, the resistive stress sensor in the vibration triggering device detects the decrease in surrounding rock stress and transmits an electrical signal to the electrical signal control valve through a transmission wire. The electrical signal control valve generates high temperature through a micro current to break through the safety film, instantly gasifying the liquid CO₂ in the chamber. The rapidly expanding CO₂ gas generates high-pressure vibration waves to break the shear plate, and then discharges it from the pressure relief valve, and applies its own high-pressure strong energy vibration waves to the surrounding rock medium, thereby simulating the high-energy and strong vibration phenomenon caused by the dynamic load impact of compressed air generated by the fracture of the thick-hard rock layers.

b. continuing excavation until the coal seam excavation is completed. After a vibration triggering simulation, excavation can continue to trigger the next high-energy and strong vibration by the fracture of the high-level thick-hard rock layer, thus conducting multiple high-energy and strong vibration simulations.

c. underground monitoring and surface monitoring are used to obtain micro deformation and fracture information of the surrounding rock underground, residual energy intensity information of the mining location, and vibration velocity information in three mutually perpendicular directions.

The following provides a detailed explanation of a method and device for monitoring generation of coal mine vibration and its response to vibration wave, using a mine with frequent mine vibrations as an example, based on specific implementation data.

### A: Engineering Geological Survey

The engineering geological parameters of the mining area are researched to obtain:

The thickness, lithology, and stratigraphic sequence of the rock layers in the entire formation. The survey found that there are only two layers of rock layers with a thickness of over 60 m in the entire formation, as shown in FIG. 6.

The thicknesses are 68 m and 216 m respectively;

The vertical distance from the coal seam H₁=239 m, H₂=405 m;

Ultimate tensile strength σₜ₁=7.8 MPa, σₜ₂=5.9 MPa;

Elastic modulus E₁=57.326 GPa, E₂=46.293 GPa;

Poisson's ratio v₁=0.27, v₂=0.31;

Hardness coefficient f₁=6.2, f₂=5.3;

Maximum deflection w₁=1.22, w₂=2.65.

The average bulk density of the rock layers in the formation is calculated as γ=26 kN/m³;

The original rock stresses σ₁₁, σ₂₁, σ₃₁ at the first high-level thick-hard rock layer are 57 MPa, 36 MPa, and 16 MPa, respectively;

The original rock stresses σ₁₂, σ₂₂, σ₃₂ at the second high-level thick-hard rock layer are 45 MPa, 33 MPa, and 13 MPa, respectively.

The research shows that the comprehensive fracture angle of the rock layers in a stope face is α=65°, the average burial depth of the coal seam is 877 m, the stope face slant length is Sₗ=270 m, and there are no large fault structures near the stope face.

### B: Determining the Location of the Vibration Source

Determining the spatial position of the high-level thick-hard rock layers

According to the location and strength of the rock layers determined by the engineering geological survey in step A, and comparing with the parameters of the high-level thick-hard rock layers in Table 1, the final scores fₙ of the three types of parameters for the two rock layers are:

$${F}_{1} = A \times {B}^{T} = [ \begin{matrix}0.5 \\ 0.2 \\ 0.3\end{matrix} ] \times [ \begin{matrix}85 & 90 & 75\end{matrix} ] = 83$$

$${F}_{2} = A \times {B}^{T} = [ \begin{matrix}0.5 \\ 0.2 \\ 0.3\end{matrix} ] \times [ \begin{matrix}80 & 80 & 100\end{matrix} ] = 86$$

The comprehensive scores F1 and F2 of the rock layers are both greater than 80, therefore, both rock layers are the high-level thick-hard rock layers that can generate high-energy and strong vibrations; Their thicknesses are recorded as h₁=68, h₂=216.

### Calculating the Fracture Distance of the High-Level Thick-Hard Rock Layers

According to the calculation parameters for the fracture of the high-level thick-hard rock layers obtained from the engineering geological survey in step A, taking 2=1.0 according to the actual geological conditions, and substituting it into the calculation formula for the fracture position, the fracture spans L_{d1} and L_{d2} of the two high-level thick-hard rock layers in the engineering site are calculated separately. The results are as follows:

$${L}_{d 1} = λ \cdot \sqrt{\frac{2 {h}_{1} \cdot {σ}_{t 1}}{γ}} = 1. \times \sqrt{\frac{2 \times 68 \times 7.8}{0.026}} \approx 202 m$$

$${L}_{d 2} = λ \cdot \sqrt{\frac{2 {h}_{2} \cdot {σ}_{t 2}}{γ}} = 1. \times \sqrt{\frac{2 \times 216 \times 5.9}{0.026}} \approx 313 m$$

Calculating the corresponding stope face mining distance L_{c1}, L_{c2} when the high-level thick hard rock layer breaks:

$${L}_{c 1} = {L}_{d 1} + 2 {H}_{1} cot α = 202 + 2 \times 239 \times cot 65 ° \approx 425 m$$

$${L}_{c 2} = {L}_{d 2} + 2 {H}_{2} cot α = 313 + 2 \times 405 \times cot 65 ° \approx 691 m$$

Based on the research, the average burial depth of the coal seam is determined to be 877 m. The model similarity ratio k is determined to be 1:300. Then, based on the similarity ratio, the distance x₀ₙ from the vibration source position to the excavation starting position and the corresponding excavation distance L_{wn} are estimated for indoor experiments. The specific results are as follows:

$${x}_{01} = k \cdot {L}_{d 1} = 1 / 300 \times 202 \approx 0.67 m$$

$${L}_{w 1} = k \cdot {L}_{c 1} = 1 / 300 \times 425 \approx 1.42 m$$

$${x}_{02} = k \cdot {L}_{d 2} = 1 / 300 \times 313 \approx 1.04 m$$

$${L}_{w 2} = k \cdot {L}_{c 2} = 1 / 300 \times 691 \approx 2.3 m$$

That is to say, the two high-level thick-hard rock layers will break near 1.42 m and 2.3 m respectively when the model is excavated.

### C: Determining the True Energy of the Vibration Source

The elastic energy accumulated under triaxial stress in the rock mass is calculated as follows:

$${E}_{t 1} = ξ \cdot \frac{[ {σ}_{11}^{2} + {σ}_{21}^{2} + {σ}_{31}^{2} - 2 {υ}_{1} ( {σ}_{11} {σ}_{21} + {σ}_{11} {σ}_{31} + {σ}_{21} {σ}_{31} ) ]}{2 \cdot {E}_{1}} = 100 \times \frac{[ {57}^{2} + {36}^{2} + {16}^{2} - 2 \times 0.27 \times ( 57 \times 36 + 57 \times 16 + 36 \times 16 ) ]}{2 \times 57.326} \approx 2.52 \times {10}^{6} J$$

$${E}_{t 2} = ξ \cdot \frac{[ {σ}_{12}^{2} + {σ}_{22}^{2} + {σ}_{32}^{2} - 2 {υ}_{2} ( {σ}_{12} {σ}_{22} + {σ}_{12} {σ}_{32} + {σ}_{22} {σ}_{32} ) ]}{2 \cdot {E}_{2}} = 100 \times \frac{[ {45}^{2} + {33}^{2} + {13}^{2} - 2 \times 0.31 \times ( 45 \times 33 + 45 \times 13 + 13 \times 33 ) ]}{2 \times 46.293} \approx 1.872 \times {10}^{6} J$$

The potential energy generated during the fracture of the high-level thick-hard rock layers is calculated as follows:

$$Δ {h}_{1} = {w}_{1} = 1.22 m$$

$${E}_{s 1} = q \cdot {h}_{1} \cdot {L}_{d 1} \cdot {S}_{l} \cdot γ \cdot Δ {h}_{1} = 0.5 \times {10}^{- 4} \times 68 \times 202 \times 270 \times 26 \times {10}^{3} \times 1.22 \approx 5.882 \times {10}^{6} J$$

$$Δ {h}_{2} = {w}_{2} = 2.65 m$$

$${E}_{s 2} = q \cdot {h}_{2} \cdot {L}_{d 2} \cdot {S}_{l} \cdot γ \cdot Δ {h}_{2} = 0.5 \times {10}^{- 4} \times 216 \times 313 \times 270 \times 26 \times {10}^{3} \times 2.65 \approx 6.289 \times {10}^{7} J$$

The total energy at the vibration source position of the high-level thick-hard rock layer is as follows:

$${E}_{D 1} = {k}_{d} \cdot ( {E}_{t 1} + {E}_{s 1} ) = 1.1 \times ( 2.520 \times 1 {0}^{6} + 5.882 \times 1 {0}^{6} ) \approx 9.2422 \times 1 {0}^{6} J$$

$${E}_{D 2} = {k}_{d} \cdot ( {E}_{t 2} + {E}_{s 2} ) = 1.1 \times ( 1.872 \times 1 {0}^{6} + 6.289 \times 1 {0}^{7} ) \approx 7.1238 \times 1 {0}^{7} J$$

### D: Determining the Equivalent Energy of the Vibrations

The specific calculation of blasting energy in the CO₂ detonation device is as follows:

$${E}_{g 1} = \frac{1}{η} \cdot k \cdot {E}_{D 1} = \frac{1}{0.85} \times \frac{1}{300} \times 9.2422 \times 1 {0}^{6} \approx 3.6244 \times 1 {0}^{4} J$$

$${E}_{g 2} = \frac{1}{η} \cdot k \cdot {E}_{D 2} = \frac{1}{0.85} \times \frac{1}{300} \times 7.1238 \times 1 {0}^{7} \approx 2.7936 \times 1 {0}^{5} J$$

The specific peak pressure of CO₂ gas inside the fracturing tube is calculated according to the following formula:

$${P}_{g 1} = ζ \cdot \frac{2 {σ}_{s} \cdot {δ}_{1}}{{R}_{1}} = 0.85 \times \frac{2 \times 370 \times 0.37}{10} \approx 23.27 MPa$$

$${P}_{g 2} = ζ \cdot \frac{2 {σ}_{s} \cdot {δ}_{2}}{{R}_{2}} = 0.85 \times \frac{2 \times 370 \times 0.52}{10} \approx 32.71 MPa$$

Furthermore, the volumetric amount of CO₂ used is:

$${V}_{1} = {k}_{v} \cdot \frac{{E}_{g 1} \cdot ( K - 1 )}{{P}_{g 1}} [ 1 - {( \frac{{P}_{0}}{{P}_{g 1}} )}^{\frac{K - 1}{K}} ]$$

$${V}_{1} = 0.1 \times \frac{3.6244 \times 1 {0}^{4} \times 0.295}{23.27 \times 1 {0}^{6}} [ 1 - {( \frac{0.1013}{23.27} )}^{\frac{0.295}{1.295}} ] \approx 0.3263 \times 1 {0}^{- 4} {m}^{3}$$

$${V}_{2} = {k}_{v} \cdot \frac{{E}_{g 1} \cdot ( K - 1 )}{{P}_{g 1}} [ 1 - {( \frac{{P}_{0}}{{P}_{g 1}} )}^{\frac{K - 1}{K}} ]$$

$${V}_{2} = 0.1 \times \frac{2.7936 \times 1 {0}^{5} \times 0.295}{32.71 \times 1 {0}^{6}} [ 1 - {( \frac{0.1013}{32.71} )}^{\frac{0.295}{1.295}} ] \approx 1.8438 \times 1 {0}^{- 4} {m}^{3}$$

Therefore, the volume of CO₂ required to trigger strong vibrations in two high-level thick-hard rock layers is: 0.3263×10⁻⁴ m³, 1.8438×10⁻⁴ m³.

### E: Simulation and Response Monitoring of Vibration Triggering Process

According to the present disclosure, a method for monitoring generation of coal mine vibration and its response to vibration wave:
laying similar simulation experimental models;
burying multiple vibration source triggering devices at the corresponding fracture positions in two high-level thick-hard rock layers;
simulating multiple high-energy and strong vibrations triggering.

Finally, according to specific research needs, monitoring will be conducted underground or on the surface.

In this example, multiple measuring points are arranged to study the attenuation rule of the vibration velocity of buildings with distance during the propagation of the vibrations. The results are shown in FIG. 8.

Certainly, the above descriptions are merely preferred embodiments of the present disclosure. The present disclosure is not limited to the above embodiments listed. It should be noted that, all equivalent replacements and obvious variations made by any person skilled in the art under the teaching of the specification fall within the essential scope of the specification and shall be protected by the present disclosure.

What is claimed is:

1. A method for monitoring generation of coal mine vibration and its response to vibration wave, comprising:
S1, determining a number and spatial location of high-level thick-hard rock layers in an entire formation of a mining area,
S1-1 investigating a thickness, lithology, and stratigraphic sequence of rock layers in the entire formation,
S1-2 measuring and calculating engineering geological parameters of the rock layers in the entire formation of the mining area, including a vertical distance Hₙ between the rock layers with a single layer thickness of over 60 m and the coal seam, a ultimate tensile strength σₜₙ of the rock layers, a hardness coefficient fₙ of the rock layers, an elastic modulus Eₙ of the rock layers, a Poisson's ratio vₙ, and a maximum deflection wₙ of the rock layers; an average bulk density of the rock layers γ, and an original rock stress at the rock layers with a single layer thickness over 60 m σ₁ₙ, σ₂ₙ, σ₃ₙ; a comprehensive fracture angle α of the rock layers in a stope face, a burial depth of the coal seam, and a stope face slant length Sₗ,
S1-3 determining a number and an arrangement of the high-level thick-hard rock layers based on the engineering geological parameters of the rock layers calculated by S1-2, wherein, the rock layers located more than 150 m away from the coal seam and with a comprehensive score fₙ greater than 80 are identified as the high-level thick-hard rock layers capable of generating high-energy and strong vibrations;
S2, based on the engineering geological parameters obtained in step S1, calculating a fracture length L_{dn} when each of the high-level thick-hard rock layers break and a corresponding stope face mining distance L_{cn} when each of the high-level thick-hard rock layers breaks, and determining a similarity ratio k of an experimental model based on a coal seam burial depth in the area where the coal seam is located and actual spatial conditions in a laboratory, and based on the similarity ratio k, calculating a distance x₀ₙ from a vibration source position of the experimental model to an excavation starting position, as well as a corresponding excavation distance L_{wn};
S3, calculating a true energy E_{Dn} for the fracture of the high-level thick-hard rock layers; and
using a vibration triggering device to generate vibration source energy, the vibration source energy used in the vibration triggering device is a CO₂ detonation device, and calculating an equivalent relationship between the true energy E_{Dn} generated by the fracture of the high-level thick-hard rock layers in the area where the coal seam is located and an equivalent energy E_{gn} released by the CO₂ detonation device of the vibration triggering device;
S4, laying high-level thick-hard simulation rock blocks within a height adjustable frame, from bottom to top of the formation, and during laying of the high-level thick-hard simulation rock blocks, according to the distance x₀ₙ from the vibration source position of the experimental model calculated in step S2 to the excavation starting position, burying the vibration triggering device at the corresponding position in the formation; after laying the experimental model, the frame is at least 20 cm higher than the formation; installing an underground monitoring system at the bottom or front of the experimental model to monitor strong vibration impact on underground buildings; installing an surface building model at the top of the experimental model, and installing an surface monitoring system at a height of 10 cm above the surface building model;
S5, simulating triggering of the strong vibrations:
a. simulating coal seam mining in the stope face, and slowing down an excavation speed when the excavation reaches the distance L_{wn} or nL_{wn} where the high-level thick-hard rock layer is fractured, the vibration triggering device operates and triggers a high-energy and strong vibration phenomenon;
b. continuing excavation until the coal seam excavation is completed, after vibration triggering simulation, continuing excavation to trigger the next high-energy and strong vibration by the fracture of the high-level thick-hard rock layer, thus conducting multiple high-energy and strong vibration simulations;
c. the underground monitoring system and surface monitoring system obtain micro deformation and fracture information of a surrounding rock underground, a residual energy intensity information of the mining location, and a vibration velocity information in three mutually perpendicular directions on the surface, which are used to analyze the strong vibration impact in the actual mining area.

2. A device for monitoring generation of coal mine vibration and its response to vibration wave according to claim 1, wherein the comprehensive score of the high-level thick-hard rock layer is obtained by three parameters: the ultimate tensile strength σₜₙ, the hardness coefficient fₙ, a rock layer thickness hₙ, and their respective weights, comprising:
combining weight factors of the ultimate tensile strength σₜₙ, the hardness coefficient fₙ, and the rock layer thickness hₙ into a matrix A,
$$A = [ \begin{matrix}α \\ β \\ γ\end{matrix} ]$$
combining the ultimate tensile strength σₜₙ, the hardness coefficient fₙ, and the rock layer thickness hₙ into a matrix B,
$$B = [ \begin{matrix}{σ}_{t n} \\ {f}_{n} \\ {h}_{n}\end{matrix} ]$$
a final score Fₙ for the three parameters is:
$${F}_{n} = A \times {B}^{T} = [ \begin{matrix}α \\ β \\ γ\end{matrix} ] \times [ \begin{matrix}{σ}_{t n} & {f}_{n} & {h}_{n}\end{matrix} ]$$
the weights of σₜₙ, fₙ, and hₙ in matrix A are α=0.5, β=0.2, and γ=0.3;
the scoring values of σₜₙ, fₙ, and hₙ in matrix B are obtained from Table 1;
TABLE 1

| Parameters | | | Values and score changing range | | | | |
|---|---|---|---|---|---|---|---|
| 1 | ultimate | σₜₙ | <4 | 4~6 | 6~8 | 8~12 | >12 |
| | tensile | Score | 50 | 80 | 85 | 90 | 100 |
| | strength/MPa | | | | | | |
| 2 | hardness | fₙ | 2~4 | 4~6 | 6~8 | 8~10 | >10 |
| | coefficient | Score | 50 | 80 | 90 | 95 | 100 |
| 3 | rock layer | hₙ | <50 | 50~80 | 80~120 | 120~160 | >160 |
| | thickness/m | Score | 30 | 75 | 80 | 95 | 100 |

if the comprehensive score Fₙ is greater than 80, the rock layer is judged as the high-level thick-hard rock layer that can generate the high-energy and strong vibrations; according to the results, the thicknesses of the thick-hard rock layers in the formation are recorded from near to far from the coal seam as h₁, h₁ . . . hₙ.

3. A device for monitoring generation of coal mine vibration and its response to vibration wave according to claim 1, wherein a calculation formula for the true energy E_{Dn} of the fracture of the high-level thick-hard rock layer is:
$${E}_{D n} = {k}_{d n} \cdot ( {E}_{t n} + {E}_{s n} )$$
wherein, E_{Dn} is the true energy of the fracture of the high-level thick-hard rock layers, in units of J; k_{dn} is a stress transfer coefficient caused by rock excavation, which is 1.0-1.1; Eₜₙ is an elastic energy accumulated under triaxial stress within the rock mass, in units of J; Eₛₙ is a potential energy generated during the fracture of the high-level thick-hard rock layers, in units of J;
the elastic energy Eₜₙ accumulated under triaxial stress in the rock mass is calculated by:
$${E}_{tn} = ξ \cdot \frac{[ {σ}_{1 n}^{2} + {σ}_{2 n}^{2} + {σ}_{3 n}^{2} - 2 {υ}_{n} ( {σ}_{1 n} {σ}_{2 n} + {σ}_{1 n} {σ}_{3 n} + {σ}_{2 n} {σ}_{3 n} ) ]}{2 {E}_{n}}$$
wherein, ξ is an elastic energy accumulation parameter, taken as 100; σ₁ₙ, σ₂ₙ, and σ₃ₙ are three principal stresses in the rock mass, in units of MPa; vₙ is the Poisson's ratio of the rock mass; Eₙ is the elastic modulus, in units of GPa;
the potential energy Eₛₙ generated by the fracture of the high-level thick-hard rock layers is calculated by:
$${E}_{s n} = q \cdot {h}_{n} \cdot {L}_{d n} \cdot {S}_{l} \cdot γ \cdot Δ {h}_{n}$$
$$Δ {h}_{n} = {w}_{n}$$
wherein, q is an effective potential energy coefficient, taken as 0.5×10⁻³; hₙ, L_{dn}, and Sₗ are the thickness, the fracture length, and the stope face slant length of the high-level thick-hard rock layers, respectively, in meters; γ is an average bulk density of the formation, measured in kN/m³; Δhₙ is an equivalent subsidence, in meters; wₙ is a maximum disturbance value of the corresponding rock layer.

4. A device for monitoring generation of coal mine vibration and its response to vibration wave according to claim 1, wherein the equal relationship between the true energy E_{Dn} of the fracture of the high-level thick-hard rock layer and the equivalent energy E_{gn} released by the CO₂ detonation device of the vibration triggering device is:
$${E}_{Dn} = \frac{1}{k} \cdot {E}_{gn} \cdot η$$
wherein, E_{Dn} is the true energy of the fracture of the high-level thick-hard rock layers, in units of J; k is the similarity ratio of the experimental model; E_{gn} is the equivalent energy released by the CO₂ detonation device, in units of J; η is an overall energy utilization rate of the vibration triggering device, taken as 0.85;
a peak pressure of CO₂ gas inside the vibration triggering device is calculated by:
$${P}_{gn} = ζ \cdot \frac{2 {σ}_{s} {δ}_{n}}{{R}_{n}}$$
wherein, P_{gn} is a peak gas burst pressure, measured in Pa; ζ is a conversion coefficient between a fracturing tube used in the vibration triggering device and a standard CO₂ fracturing tube, usually taken as 0.76-0.95; Rₙ is a radius of a discharge hole, measured in millimeters; σₛ is a shear strength of a shear plate material, taken as 370 MPa; δₙ is thickness of the shear plate, measured in millimeters;
the formula for calculating a volume usage of CO₂ is:
$${V}_{n} = {k}_{v} \cdot \frac{{E}_{g n} \cdot ( K - 1 )}{{P}_{g n}} [ 1 - {( \frac{{P}_{0}}{{P}_{g n}} )}^{\frac{K - 1}{K}} ]$$
wherein, Vₙ is a volume of CO₂ used, measured in cubic meters; kᵥ is an energy density coefficient, taken as 0.1; E_{gn} is the equivalent energy released by the CO₂ detonation device, in units of J; P_{gn} is the gas burst pressure, in units of Pa; P₀ is a standard atmospheric pressure, taken as 0.1013 MPa; K is an adiabatic coefficient of CO₂, taken as 1.295.

5. A device for monitoring generation of coal mine vibration and its response to vibration wave, comprising:
a height adjustable frame used to simulate a distribution structure of high-level thick-hard rock layers in a stope face;
a vibration triggering device, installed at a suitable position on the frame; the vibration triggering device comprises a fracturing tube, a vibration triggering device, a pressure relief valve, and a triggering mechanism, the vibration triggering device is fixedly installed inside the fracturing tube, the pressure relief valve is set inside the fracturing tube, and the triggering mechanism is fixedly installed outside the fracturing tube;
the vibration triggering device comprises a housing, a blocking stopper, and a shear plate; two ends of the housing are open, and a top end of the housing is sealed by a safety film, a bottom end is equipped with a blocking stopper, which is a hollow structure; a circular flange is provided in the middle of the housing, and the shear plate is installed between the circular flange and the blocking stopper; the safety film, the shear plate, and the housing form a chamber for storing liquid CO₂;
the fracturing tube is equipped with a fracturing tube stopper inside, which is located directly below the vibration triggering device and opposite to the blocking stopper, the fracturing tube stopper and the blocking stopper form a pressure relief valve, which provides a high-pressure vibration wave discharging channel for the liquid CO₂ after gasification;
the triggering mechanism is used to sense stress changes and trigger the operation of the vibration triggering device, the operation of the vibration triggering device provides source energy, which impacts and destroys the fracturing tube through the pressure relief valve, thereby enabling the vibration triggering device to operate and provide vibration source energy to a surrounding environment;
an surface building model installed at the top of the frame; and a vibration wave response monitoring device comprising:
an surface monitoring system installed above the frame and at a height higher than an installation height of the surface building model, used to monitor impacts of high-energy and strong vibrations on buildings; and
an underground monitoring system installed at the bottom or front of the frame to monitor the relevant vibration impact on underground structures.

6. A device for monitoring generation of coal mine vibration and its response to vibration wave according to claim 5, wherein the underground monitoring system includes an acoustic emission device and a microseismic monitoring device, the acoustic emission device is used to detect microscopic deformation and fracture of surrounding rocks caused by strong mine vibrations underground; the microseismic monitoring device is used to monitor a residual energy intensity transmitted to a mining site after an interaction and energy attenuation of the surrounding rocks caused by the vibrations generated by the source location.

7. A device for monitoring generation of coal mine vibration and its response to vibration wave according to claim 5, wherein the surface monitoring system includes a blasting vibration instrument, including a three-way vibration sensor and a signal acquisition instrument, which can automatically record and analyze a vibration velocity in three mutually perpendicular directions.

8. A device for monitoring generation of coal mine vibration and its response to vibration wave according to claim 5, wherein the triggering mechanism is installed above the safety film, and the triggering mechanism comprises a resistive stress sensor, a transmission wire, and an electrical signal control valve, the electrical signal control valve is installed in contact with the safety film and is connected to the resistive stress sensor through the transmission wire.

9. A device for monitoring generation of coal mine vibration and its response to vibration wave according to claim 5, wherein the frame comprises two bases, on which longitudinal support components capable of being raised are installed, and the longitudinal support components are connected and fixed by bottom beams, the longitudinal support components are installed with front and rear beams arranged in parallel from bottom to top, and are respectively installed on the front and rear sides of the longitudinal support components, a space for laying the high-level thick-hard simulation rock blocks is formed between the front and rear beams and the longitudinal support components, the height of the longitudinal support components and the number of front and rear beams can be changed according to the thickness of the high-level thick-hard simulation rock blocks laid, a vibration triggering device is installed inside the high-level thick-hard rock simulation block.

10. A device for monitoring generation of coal mine vibration and its response to vibration wave according to claim 9, wherein the longitudinal support component comprises multiple structural units connected and installed by bolt stacking, and the height of the longitudinal support component relative to the base is changed by increasing the number of stacking of the structural units, to meet the height requirements of the experiment.

11. A device for monitoring generation of coal mine vibration and its response to vibration wave according to claim 5, wherein at least three vibration triggering devices are installed at positions x₀ₙ−δ, x₀ₙ, x₀ₙ+δ, wherein δ is 5-10 cm.
